(19) United States
(12) Patent Application Publication
(10) Pub. No.: US 2003/0144825 A1
(43) Pub. Date: Jul. 31, 2003

(54) Prediction method and apparatus for delay and skew analysis

(76) Inventor: Alexander I Korobkov, Sunnyvale, CA (US)

Correspondence Address: BLAKELY, SOKOLOFF, TAYLOR & ZAFMAN LLP, Seventh Floor, 12400 Wilshire Boulevard, Los Angeles, CA, 90025-1030, US

(21) Appl. No.: 10/059,659

(22) Filed: Jan. 28, 2002

(51) Int. Cl. G06F 17/50

(52) U.S. Cl. 703/14

(57) ABSTRACT

The present invention, which may be implemented on a general-purpose digital computer, in certain embodiments includes novel methods and apparatus to provide accurate prediction for skew or delay analysis in complex multi-stage signal paths with mutual couplings between the stages. In some embodiments, single or multiple processors are utilized to implement the present invention.

### FIELD OF INVENTION

The present invention generally relates to verifying signal behavior in integrated circuits (ICs). More specifically, the present invention relates to techniques for delay and skew analysis.

### BACKGROUND OF INVENTION

Current levels of silicon technology permit implementing ICs with relatively high complexity and performance. At the same time, noise issues such as those created by cross talk are limiting the progress of the silicon technology. The problems associated with crosstalk and skew are becoming even more important due to its significant impact on overall chip performance and functionality.

Skew is generally defined as a change of timing or phases in a signal. Crosstalk is generally described as noise resulting from cross-coupling of signals during signal transmissions. This phenomena is caused by adjacent electrical conductors carrying certain signals. When modeling circuits for simulations, coupling capacitors are utilized to provide an equivalent representation for crosstalk. The presence of coupling capacitance indicates that a circuit will have a delay proportional to the coupling capacitance. The lower the coupling capacitance, the higher the speed and hence the lower the delay of a circuit. Accordingly, simulating coupling capacitance is extremely important in circuit designs today. Correctly simulating and determining a coupling capacitance will result in accurate speed prediction and will also assist in improving the speed of a circuit by reducing the coupling capacitance present.

Moreover, it is extremely important to evaluate the impact of coupling capacitance on circuits where operating frequency is high and, therefore, strict accuracy requirements are needed. An accurate and efficient skew and delay analysis is especially important for the critical networks such as clock distribution networks and input/output networks, which may be present throughout a chip.

A technique utilized to predict and simulate the delay behavior of a circuit is application of a Miller factor. The Miller factor is a coefficient which can be multiplied with an actual capacitance value derived from the interaction of adjacent signals. For example, if the adjacent signals are both rising, the Miller factor may approach zero indicating that virtually no coupling capacitance may be present. Similarly, if the adjacent signals are rising and falling (i.e. switching) the Miller factor applied may be closer to two.

There are some conventional circuit partitioning techniques which can be applied to the original electrical circuit to separate different parts of the circuit and simulate smaller clusters which usually reduce simulation time while preserving appropriate accuracy. However, it is difficult to find disjoint circuit clusters due to the large number of coupling capacitors, which may be present among different parts of the reference circuit. Typically, standard Miller factor is applied to replace all coupling capacitors by their grounded equivalents. Application of Miller factor may, however, cause significant error in verification results especially for net-to-net couplings due to the nonlinear properties of the signals present. A net is generally defined as a group of nodes with RC elements and without any nonlinear elements such as transistors and/or drivers. And, a net-to-net coupling can be determined by separating a circuit into nets.

Well-known circuit partitioning technique is applicable to the gate level circuit netlist (defined as a list of logic gate and their interconnections which make up a circuit) to simulate the different parts of an original circuit separately. This is possible because of the metal-oxide semiconductor (MOS) transistor feature where nets connected to the gate and nets connected to the drain or source of the transistor can be considered as electrically isolated from each other due to the negligibly small current through the gate oxide. Such partitioning is illustrated in FIG. 1A.

In FIG. 1A, the first circuit 102 (Circuit 1) is a net which includes a first-level gates 104 (i.e. the gates connected to the primary inputs), parasitics 108 (with RCs connected with the first-level gates 104 and a second-level gates 106), and the second (Circuit 2) is a net which includes the second level gates 106, parasitics 112 (connected to the outputs of these gates), and the next level gates (third-level gates 114) which become an effective load for the second circuit 110 (Circuit 2).

To verify delay and skew of the nets in FIG. 1A, primary inputs are connected to the appropriate voltage sources to simulate a first circuit (for example, circuit 1 of FIG. 1A) and obtain resulting waveforms at all nodes of interest including, for example, the inputs of the next stage of buffering. After that, waveform data are stored for the next simulation step when voltage sources emulating correspondent waveforms are applied to the inputs of the following stage of buffering (for example, circuit 2 if FIG. 1A). This procedure is repeated until the primary outputs are reached. A major problem associated with this technique is the presence of coupling capacitors that connect to different parts of the partitioned circuit. As a result, these circuits cannot be correctly simulated separately due to the additional electrical dependency. To avoid this effect the coupling capacitors can be grounded (i.e. decoupled) with defined scale factors such as the Miller factor.

FIG. 1B illustrates circuit partitioning in presence of net-to-net couplings in accordance with the prior art. Using standard Miller factor conversion, the updated capacitors are generally computed at two times (2×) the original value when an inverting gate is present between two nets (see, e.g., conversion from part (a) to part (b) of FIG. 1B). Otherwise, a factor of zero may be utilized (0×) (i.e., capacitors removed altogether) as shown in conversion from part (c) to part (d) of FIG. 1B. The standard Miller factor approach may be quite reasonable for some cases, but may produce significant errors for other cases. For example, in some cases the Miller factor may in actuality reach three.

Generally, circuit designers utilize a software program, such as HSpice, provided by Avant Corporation of Fremont, Calif., to simulate the skew and delay associated with their designs. To run such simulations, however, a circuit will have to be first divided into appropriate stages. Then, each stage will have to be simulated individually. Such division is laborious and time-consuming and can delay the design process and may, in some situations, introduce human error into the process. Also, as the number of elements (which need to be simulated simultaneously) increases, the traditional techniques fail to provide an efficient, accurate, and/or even workable solution.

### SUMMARY OF INVENTION

The present invention, which may be implemented on a general-purpose digital computer, in certain embodiments includes novel methods and apparatus to provide accurate prediction for skew or delay analysis in complex multi-stage signal paths with mutual couplings between the stages. In some embodiments, single or multiple processors are utilized to implement the present invention.

In one embodiment, a method of predicting behavior of a circuit is disclosed. The method comprises: dividing the circuit into a plurality of nets, each net including RC elements; initializing a variable i to 1; linearly transforming all coupling capacitors that couple a net i to a net i+1; simulating a net i+1 with an input voltage waveform; decoupling the net i; simulating the net i; storing a result of the act of simulating the net i; and if a primary output of the circuit is not reached, providing the stored result of simulating the net i to an input of the net i+1 and incrementing i by 1.

In another embodiment, the circuit includes both linear and nonlinear elements.

### BRIEF DESCRIPTION OF DRAWINGS

The present invention may be better understood and it's numerous objects, features, and advantages made apparent to those skilled in the art by reference to the accompanying drawings in which:

FIG. 1A illustrates circuit partitioning in accordance with the prior art;

FIG. 1B illustrates circuit partitioning in presence of net-to-net couplings in accordance with the prior art;

FIG. 2 illustrates an exemplary computer system 200 in which the present invention may be embodied;

FIG. 3A illustrates an exemplarily circuit 300 to be analyzed in accordance with an embodiment of the present invention;

FIG. 3B illustrates an exemplary circuit 320 representing the second circuit 304 of FIG. 3A after application of linear transformation in accordance with an embodiment of the present invention;

FIG. 3C illustrates an exemplary circuit 340 representing the first circuit 302 of FIG. 3A after local decoupling in accordance with an embodiment of the present invention;

FIGS. 4A and 4B illustrate exemplary circuit models 400 and 450 for implementation of linear transformation; and

FIG. 5 illustrates an exemplarily flow diagram of a method 500 in accordance with an embodiment of the present invention.

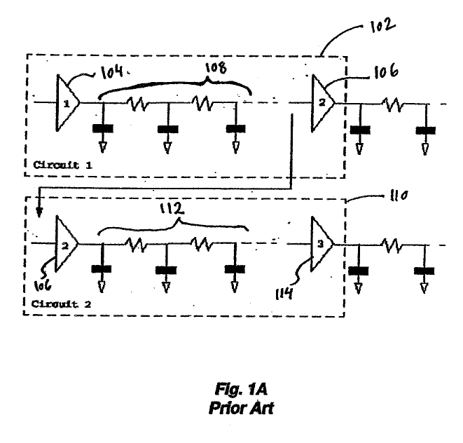

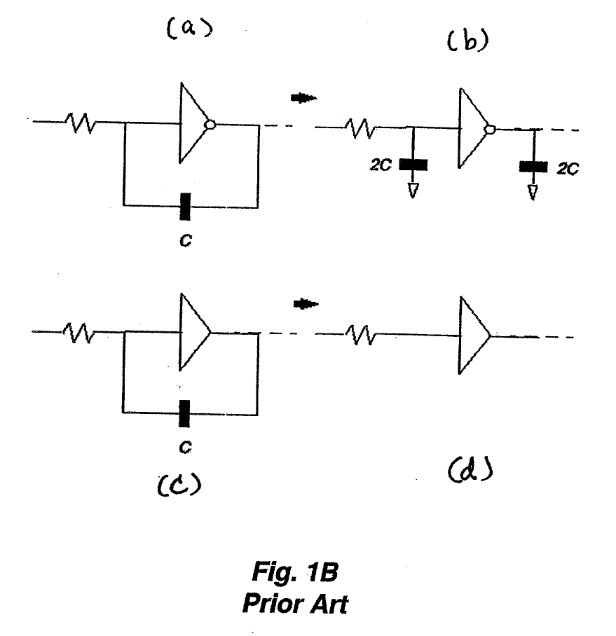

The use of the same reference symbols in different drawings indicates similar or identical items.

### DETAILED DESCRIPTION

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

As circuits are quickly becoming more complicated, coupling capacitance analysis, as with many other circuit analysis techniques, is becoming increasingly computerized. Also, as circuits grow in complexity (sometimes reaching thousands of gates), it is imperative to decrease the number of computer resources and hours spent on evaluating these designs. This is extremely important with respect to coupling capacitance analysis. Especially, in the current climate of competition, it is imperative that an accurate estimation of the speed of a circuit be determined before investing substantial amounts of money on making and marketing a device that may be dwarfed by solutions from competitors. Also, it is envisioned that an accurate coupling capacitance simulation can assist a designer in decreasing the delay and/or skew associated with a circuit.

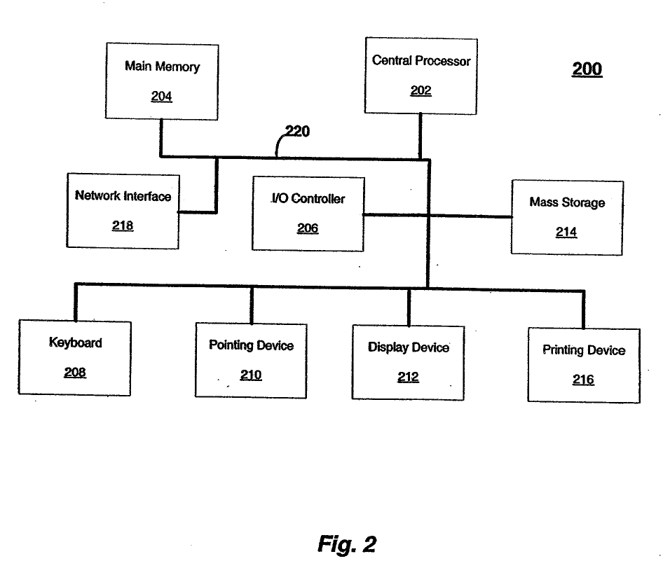

FIG. 2 illustrates an exemplary computer system 200 in which the present invention may be embodied in some embodiments. The system 200 comprises a central processor 202, a main memory 204, an input/output (I/O) controller 206, a keyboard 208, a pointing device 210 (e.g., mouse, track ball, pen device, or the like), a display device 212, a mass storage 214 (e.g., hard disk, optical drive, or the like), and a network interface 218. Additional input/output devices, such as printing device 216, may be included in the system 200 as desired. As illustrated, the various components of the system 200 communicate through a system bus 220 or similar architecture.

In an embodiment, the computer system 200 includes a Sun Microsystems computer utilizing a SPARC microprocessor available from several vendors (including Sun Microsystems of Palo Alto, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.). Also, instead of a single processor, two or more processors (whether on a single chip or on separate chips) can be utilized to provide speedup in operations.

The network interface 218 provides communication capability with other computer systems on a same local network, on a different network connected via modems and the like to the present network, or to other computers across the Internet. In various embodiments, the network interface 218 can be implemented in Ethernet, Fast Ethernet, wide-area network (WAN), leased line (such as T1, T3, optical carrier 3 (OC3), and the like), digital subscriber line (DSL and its varieties such as high bit-rate DSL (HDSL), integrated services digital network DSL (IDSL), and the like), time division multiplexing (TDM), asynchronous transfer mode (ATM), satellite, cable modem, and FireWire.

Moreover, the computer system 200 may utilize operating systems such as Solaris, Windows (and its varieties such as NT, 2000, XP, ME, and the like), HP-UX, Unix, Berkeley software distribution (BSD) Unix, Linux, Apple Unix (AUX), and the like. Also, it is envisioned that in certain embodiments, the computer system 200 is a general purpose computer capable of running any number of applications such as those available from companies including Oracle, Siebel, Unisys, Microsoft, and the like.

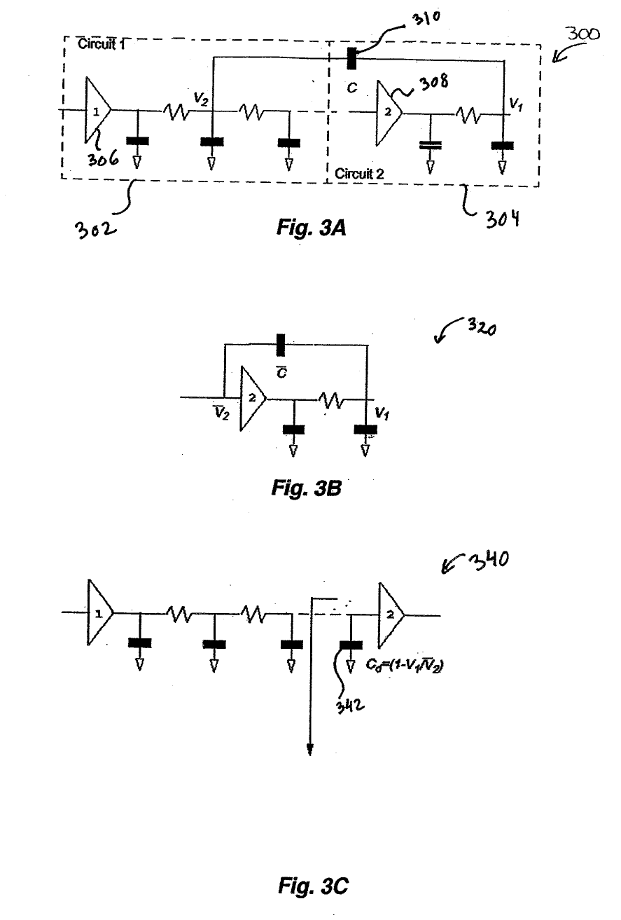

FIG. 3A illustrates an exemplarily circuit 300 to be analyzed in accordance with an embodiment of the present invention. The circuit 300 includes a first circuit 302 (Circuit 1) and a second circuit 304 (Circuit 2). As illustrated, the first circuit 302 includes RC elements and a driver 306. Similarly, the second circuit 304 includes RC elements and a driver 308. The circuit further includes a coupling capacitor 310 (C).

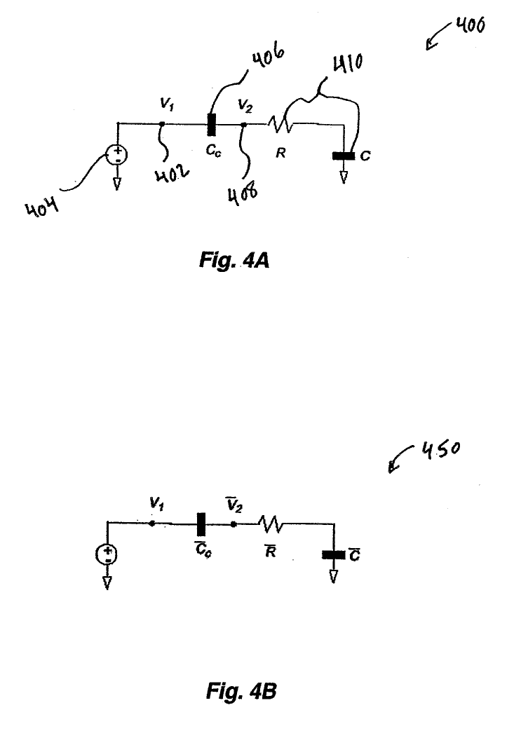

FIG. 3B illustrates an exemplary circuit 320 representing the second circuit 304 of FIG. 3A after application of linear transformation in accordance with an embodiment of the present invention. The linear transformation is performed by connecting all coupling capacitors between the two particular nets being considered to the inputs of the current stage gates. Further details with respect to linear transformation will be discussed in connection with FIGS. 4A and 4B.

FIG. 3C illustrates an exemplary circuit 340 representing the first circuit 302 of FIG. 3A after local decoupling in accordance with an embodiment of the present invention. In certain embodiments, at this stage, resistors and capacitors for the second circuit 304 of FIG. 3A may be removed, as they will not have any effect on the implementation of those embodiments of the present invention. As illustrated a decoupling capacitor 342 may be calculated as illustrated in FIG. 3C.

Linear transformation can be done based on exemplary circuit models 400 and 450 of FIGS. 4A and 4B. In FIG. 4A, a first source node 402 is connected to a voltage source 404, which injects current into the linear circuit. In some embodiments, the coupling capacitor C_{c} (406) is equivalent to the capacitor 310 of FIG. 3A. The coupling capacitor C_{c} (406) is connected to the first source node 402 and node 408 which can be considered as a driving point node for the RC paths connecting node 408 and ground (except for node 406), and therefore such a circuit may be represented by a reduced order model where RC (410) may provide an equivalent admittance of node 408 to ground.

FIG. 4B illustrates a model circuit 450 after linearly transforming the circuit 400 of FIG. 4A in accordance with an embodiment of the present invention. The voltage response under the step voltage input in time domain can be computed as shown by Equation 1 below:

$${V}_{2} ( t ) = {V}_{1} ( t ) \cdot ( ( 1 + \frac{{C}_{c}}{C ( C + {C}_{c} )} ) \cdot {ⅇ}^{- \frac{C + {C}_{c}}{C \cdot {C}_{c} \cdot R} \cdot t} - \frac{{C}_{c}}{C ( C + {C}_{c} )} ) \qquad Equation 1$$

To preserve the time constant of the transfer function for the transformed circuit, capacitance after linear transformation can be computed as shown by Equation 3 (utilizing Equations 1 and 2) below.

$$\begin{matrix}{\overline{V}}_{2} ( t ) = {V}_{1} ( t ) \cdot ( ( 1 + \frac{{\overline{C}}_{c}}{\overline{C} ( \overline{C} + {\overline{C}}_{c} )} ) \cdot {ⅇ}^{- \frac{\overline{C} + {\overline{C}}_{c}}{\overline{C} \cdot {\overline{C}}_{c} \cdot \overline{R}} \cdot t} - \frac{{\overline{C}}_{c}}{\overline{C} ( \overline{C} + {\overline{C}}_{c} )} ) \\ where & Equation 2 \\ {\overline{C}}_{c} = \frac{{C}_{c}}{1 + \frac{{C}_{c} \overline{R}}{CR} - \frac{{C}_{c}}{\overline{C}}} & Equation 3\end{matrix}$$

It is envisioned that the driving point model may be computed based on any conventional equivalent driving point admittance technique by matching the first two poles of original and reduced order circuits. In certain embodiments, all nonlinear excitations are considered the same for both the original and the transformed circuits and therefore the excitations do not have any impact on the transformation. This transformation procedure can be repeated for all coupling capacitors between the two nets in order to connect them to the next stage gate inputs. For the case of multiple driven circuits, gate inputs can be assigned arbitrarily, for example, based on the uniform distribution of reconnected capacitors between the gate inputs.

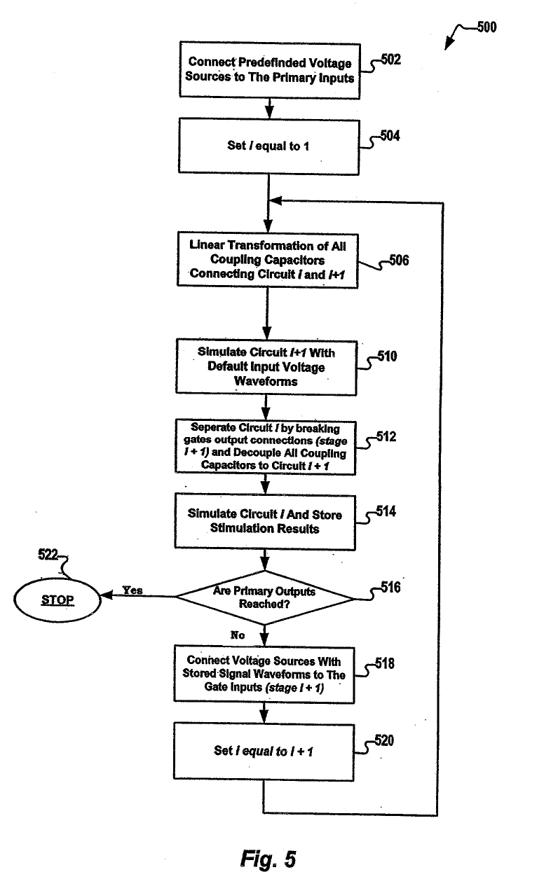

FIG. 5 illustrates an exemplarily flow diagram of a method 500 in accordance with an embodiment of the present invention. The method 500 starts with a step 502 which connects predefined voltage sources to the primary inputs. It is envisioned that connecting the predefined voltage sources to the primary inputs may be achieved by applying nonlinear waveforms to the primary inputs. In a step 504, i is set to 1. In a step 506, all coupling capacitors connecting circuits i and i+1 are linearly transformed. In step 510, a circuit i+1 (in some embodiments with default nonlinear input voltage wave forms) is simulated. It is envisioned that all coupling capacitors connecting circuit i+1 with circuits other than i may be decoupled with a Miller factor equal to 1 without noticeable loss of accuracy. As a result of applying such a technique, signal waveforms at the nodes for coupling capacitors connecting circuits i and i+1 can be computed and used to decouple those couplings with accurately predicted Miller factor (as for example shown in FIG. 3C, equation for capacitor 342).

In a step 512, circuit i is separated by breaking gates output connections (stage i+1) and decoupling all coupling capacitors to circuit i+1. In a step 514, circuit i is simulated and the results of the simulation are stored for future reference. In a step 516, it is determined whether the primary outputs have been reached. If the primary outputs have not been reached, in a step 518 all the sources are connected to the gate inputs (stage i+1) utilizing the stored signal waveforms. In a step 520, i is incremented by 1 (to i+1) and the method 500 resumes from step 506 thereafter. Alternatively, if in the step 516 it is determined that the primary outputs have been reached, the method 500 stops in a step 522.

The foregoing description has been directed to specific embodiments. It will be apparent to those with ordinary skill in the art that modifications may be made to the described embodiments, with the attainment of all or some of the advantages. For example, the techniques discussed herein may be applied utilizing other signal sources than the voltage sources discussed herein. For example, a current source or other equivalent source may be utilized. Therefore, it is the object of the appended claims to cover all such variations and modifications as come within the spirit and scope of the invention.

What is claimed is:

1. A method of predicting behavior of a circuit, the method comprising:
dividing the circuit into a plurality of nets, each net including RC elements;
initializing a variable i to 1;
linearly transforming all coupling capacitors that couple a net i to a net i+1;
simulating a net i+1 with an input voltage waveform;
decoupling the net i;
simulating the net i;
storing a result of the act of simulating the net i; and
if a primary output of the circuit is not reached, providing the stored result of simulating the net i to an input of the net i+1 and incrementing i by 1.

2. The method of claim 1 wherein each net excludes any elements selected from a group comprising a transistor and a driver.

3. The method of claim 1 wherein the circuit includes both linear and nonlinear elements.

4. The method 1 wherein the input voltage waveform includes a plurality of waveforms.

5. The method of claim 1 further including providing a predefined voltage source to a primary input of the circuit.

6. The method of claim 1 wherein the act of decoupling the net i is accomplished by:
breaking an output connection of the net i gates, and
decoupling all coupling capacitors of the net i+1.

7. The method of claim 1 wherein the result is a waveform.

8. The method of claim 1 wherein simulating a net i+1 is performed while substantially all coupling capacitors coupled to the net i+1, other than between net i and i+1, are grounded with a Miller factor of about 1.

9. The method of claim 1 wherein the decoupling is performed by utilizing a Miller factor.

10. An article of manufacture comprising:
a machine readable medium that provides instructions that, if executed by a machine, will cause the machine to perform operations including:
dividing a circuit into a plurality of nets, each net including RC elements;
initializing a variable i to 1;
linearly transforming all coupling capacitors that couple a net i to a net i+1;
simulating a net i+1 with an input voltage waveform;
decoupling the net i;
simulating the net i;
storing a result of the act of simulating the net i; and
if a primary output of the circuit is not reached, providing the stored result of simulating the net i to an input of the net i+1 and incrementing i by 1.

11. The article of claim 10 wherein the act of decoupling the net i is accomplished by:
breaking an output connection of the net i gates, and
decoupling all coupling capacitors of the net i+1.

12. The article of claim 10 wherein the circuit includes both linear and nonlinear elements.

13. The article of claim 10 wherein the input voltage waveform includes a plurality of waveforms.

14. An apparatus comprising:
dividing means to divide a circuit into a plurality of nets;
initialization means to initialize a variable i to 1;
transformation means to linearly transforming all coupling capacitors that couple a net i to a net i+1;
first simulation means to simulate a net i+1 with an input voltage waveform;
decoupling means to decouple the net i;
second simulation means for simulating the net i;
storing means to store a result of the second simulation means; and
if a primary output of the circuit is not reached, communication means for providing the stored result of the second simulation means to an input of the net i+1 and incrementation means to increment i by 1.

15. The apparatus of claim 14 wherein each net excludes any elements selected from a group comprising a transistor and a driver.

16. The apparatus of claim 14 wherein the result is a waveform.

17. A circuit simulator for predicting behavior of a circuit, the circuit simulator comprising:
a divider to divide the circuit into a plurality of nets, each net including RC elements;
an initializer to initialize a variable i to 1;
a transformer to linearly transform all coupling capacitors that couple a net i to a net i+1;
a first simulator to simulate a net i+1 with an input voltage waveform;
a decoupler to decouple the net i;
a second simulator to simulate the net i;
a storage to store a result of the second simulator; and
if a primary output of the circuit is not reached, a communication device to provide the stored result of the second simulator to an input of the net i+1 and an incrementor to increment i by 1.

18. The circuit simulator of claim 17 wherein each net excludes any elements selected from a group comprising a transistor and a driver.

19. The circuit simulator of claim 17 wherein the circuit includes both linear and nonlinear elements.

20. The circuit simulator of claim 17 wherein the input voltage waveform includes a plurality of waveforms.

21. The circuit simulator of claim 17 wherein a predefined voltage source is provided to a primary input of the circuit.

22. The circuit simulator of claim 17 wherein the decoupler decouples the net i by:
breaking an output connection of the net i gates, and
decoupling all coupling capacitors of the net i+1 .

23. The circuit simulator of claim 17 wherein the result is a waveform.

24. The circuit simulator of claim 17 wherein the decoupler utilizes a Miller factor.
